(19) United States
(12) Patent Application Publication
(10) Pub. No.: US 2024/0384156 A1
(43) Pub. Date: Nov. 21, 2024

(54) FRICTION REDUCER AND SCALE INHIBITOR

(71) Applicant: Obsidian Chemical Solutions, LLC, Midland, TX (US)

(72) Inventors: Tyler Nelson, Midland, TX (US); John Neufeld, Midland, TX (US)

(21) Appl. No.: 18/666,469

(22) Filed: May 16, 2024

Related U.S. Application Data
(60) Provisional application No. 63/466,929, filed on May 16, 2023.

(51) Int. Cl. C09K 8/52

(52) U.S. Cl. CPC C09K 8/52; C09K 2208/28

(57) ABSTRACT

A system and method for manufacturing and using a friction reducer with scale inhibitor. The system includes two components which are typically housed, delivered, and stored separately. Instead, the system has found that advantageous results can be obtained by using a friction reducing liquid with a scale inhibitor. One example includes an anionic polyacrylamide friction reducer with a polyacrylic scale inhibitor. Such components easily mix and offer excellent performance results.

### BACKGROUND OF THE INVENTION

### Priority

The present invention claims priority to U.S. Provisional No. 63/466,929 filed May 16, 2023, the entirety of which is hereby incorporated by reference.

### Technical Field

The present invention relates to a system and method for a friction reducer and scale inhibitor.

### DESCRIPTION OF RELATED ART

There are a variety of friction reducing fluids. Each has their own advantages and disadvantages. Consequently, there is a need for a friction reducing fluid which offers comparatively greater advantages.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 shows the hydration performance in both fresh water and 170k produced water in one embodiment;

FIG. 2 shows the combination fluid performance in produced water in one embodiment;

FIG. 3 shows the impact of a scale inhibitor on a differential dynamic scale loop in one embodiment;

FIG. 4 shows the performance vs divalent cations in one embodiment;

FIG. 5 shows performance with divalent/trivalent ions in one embodiment;

FIG. 6 illustrates the carbon emissions benefits of the combination fluid in one embodiment;

FIG. 7 illustrates the man-hour savings against distance to the well for various concentrations in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

A friction reducing liquid (“FRL”) has many different uses. It can be used in drilling, hydraulic fracturing, stimulation, workover and production operations.

In one embodiment the FRL comprises an AMPS copolymer liquid friction reducer. The FRL can be formulated to reduce pipe friction pressures. The FRL can comprise various copolymer liquid friction reducers.

In one embodiment, the FRL further comprises a scale inhibitor. A scale inhibitor, as used herein, refers to a component which prevents scale deposits generated during hydraulic fracturing treatments and/or workover applications. A scale inhibitor is typically a separate component added, delivered, stored, and utilized separate from the FRL.

As noted, in one embodiment the FRL comprises a scale inhibitor component. This has many advantages and benefits as discussed below.

First, having a combination FRL and scale inhibitor reduces the amount of separate chemicals, equipment, and traffic on a wellsite. This reduces possibility of spills and transfer. Further, this reduces the footprint required for storage. It also requires less deliveries and manpower.

Previously, a FRL and scale inhibitor were separately stored, delivered, and applied. This required duplicate deliveries, transfers, etc. However, by combining both the FRL and the scale inhibitor into a single product, the two separate deliveries are reduced to a single delivery. As noted, this reduces manpower, traffic, etc.

Second, having a combination FRL and scale inhibitor reduces completion cost. Previously separate pumpers would be required to transfer the FRL and the scale inhibitor. However, when they are combined into a single product, they can be pumped together. This reduces costs.

Third, because the need for separate deliveries of separate components is eliminated, the emissions required are likewise decreased. A single truck can deliver the product as opposed to separate trucks. Thus, the amount of emissions required for delivery, and pumping, are reduced.

Fourth, safety of the system is increased. Every deliver involves a safety risk because it increases traffic and machinery on the drill site. By decreasing unnecessarily duplicative deliveries and trucks, safety is increased. Further, there is always a risk with pumping and transfer of fluids on the drill site. Because two previously separate components are now simultaneously transferred, the overall safety of the system is increased.

An additional safety impact is exposure to the fluids. Because, in some embodiments, a single product which has both a FRL and a scale inhibitor, the operators are not exposed to two separate fluids. This decreases potential exposure as well as potential spills. The result is a safer, and more economically responsible drill site.

Typically, FRL manufacturers and scale inhibitors have different manufacturers. There is a financial incentive to keep these separate to sell comparatively more product.

In one embodiment the FRL can be utilized for produced and freshwater application. The combination fluid has a low cost to treat and results in high performance produced water. In one embodiment the combination fluid is not affected by varying water quality intra-stage.

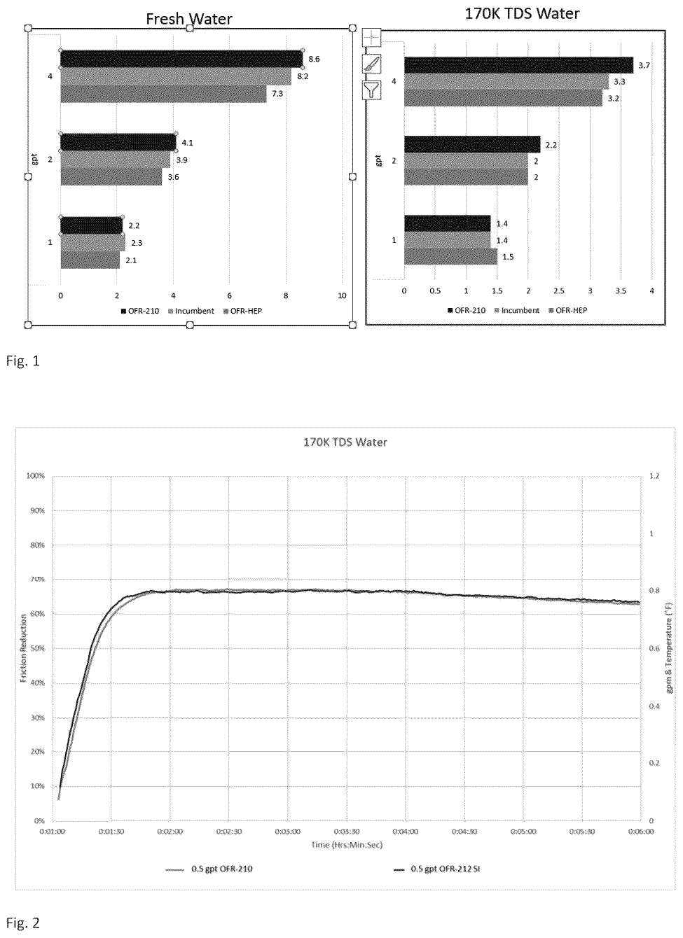

Turning now to FIG. 1, FIG. 1 shows the hydration performance in both fresh water and 170k produced water. FIG. 1 shows how the combination fluid compares against a high end HVFR and an incumbent FR. As can be seen, the combination fluid has excellent hydration viscosity.

Turning to FIG. 2, FIG. 2 shows the combination fluid performance in produced water. The combination fluid performs favorably in a variety of applications. This can include fresh water or extremely high TDS water.

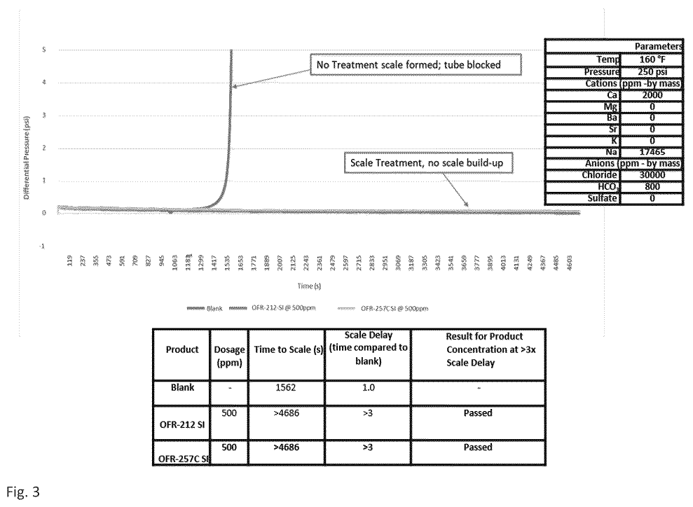

Turning to FIG. 3, FIG. 3 shows the impact of a scale inhibitor on a differential dynamic scale loop. Two different combination fluids are compared against a standard FRL which does not comprise a scale inhibitor. As can be seen, the standard FRL resulted in a blocked tube after about 1500 seconds. Conversely, the two combination fluids had no scale build up, and thus no tube blockage, for the duration of the test-4603 seconds. Thus, combining the scale inhibitor within the combination fluid did not decrease the effectiveness of the scale inhibitor. Put different, the benefits of the scale inhibitor are not reduced by combining it within a single combination product with the FRL.

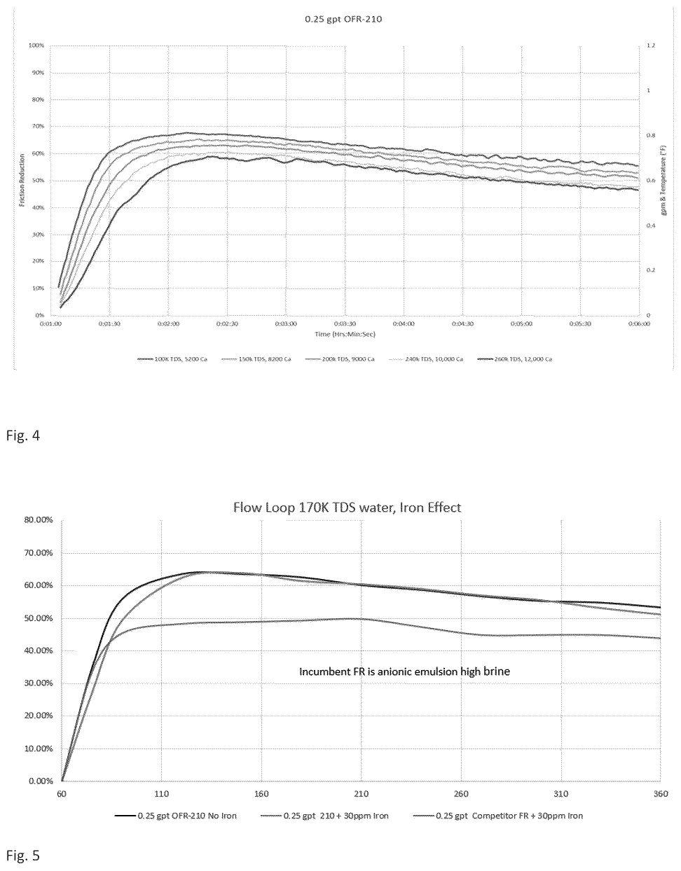

FIG. 4 shows the performance vs divalent cations in one embodiment. Divalent cations (Ca2+) can inhibit a FRL ability to effectively reduce pressure. In the embodiment tested, calcium analysis in this water was exceptionally high. Despite this, FIG. 4 demonstrates that the combination fluid is effective even in harsh waters.

FIG. 5 shows performance with divalent/trivalent ions in one embodiment. In FIG. 5, two separate combination fluids are compared with an incumbent FRL which does not have a scale inhibitor. Divalent and trivalent ions (Fe3+, Ca2+) can interfere with the ability to reduce pressure. This is particularly true in water which also contains high calcium and high iron content. Despite this, the combination fluids are still highly effective.

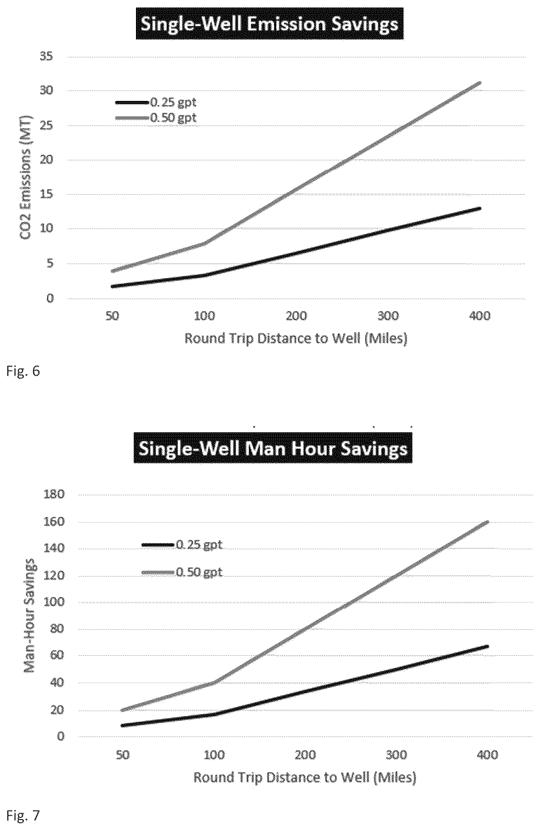

Turning now to FIG. 6, FIG. 6 illustrates the carbon emissions benefits of the combination fluid in one embodiment. FIG. 6 charts various concentrations with the distance to the well against the CO2 emissions. As noted, because separate transportation is reduced or eliminated, this results in significant reduction of CO2 emissions.

Similarly, FIG. 7 illustrates the man-hour savings against distance to the well for various concentrations in one embodiment. As shown, this reduces the hours needed to deliver separate components. This results in a decrease of needed labor, which also reduces cost.

As shown from the figures, the combination fluid is effective at various water quality levels. In one embodiment it is effective at concentrations between 0.25 to 1.0 gallons per 1,000 gallons in fresh water and brines with up to 250,000 TDS. Higher salt and TDS level waters can occasionally require higher loadings of the combination fluid.

In one embodiment, loading of 0.5 gpt of the combination fluid is equivalent to 0.5 gpt FRL plus 0.25 gpt of scale inhibitor. In one embodiment, every 0.5 gpt of the combination fluid adds 20 ppm active polymer scale inhibitor.

The specific physical properties of the combination fluid will depend upon the final formulation. In one embodiment the combination fluid is opaque white/tan. It has a density ranging from about 8.5 to about 10 pounds per gallon. In one embodiment the specific gravity is about 1.09 g/cm³. In one embodiment the freezing point is about 5F.

The FRL can be applied as it typical with other FRL's. The FRL can be used in freshwater to mid brines in turbulent flow to reduce pressure.

In one embodiment the FRL comprises an anionic FRL. In one embodiment, the FR comprises an anionic polyacrylamide.

Only certain FRLs will mix and function with specific scale inhibitors. Further, the ratio of FRLs to scale inhibitors must be carefully selected, otherwise the formulation will not sufficiently mix or function as desired. As but one example, with an incorrect ratio, the resulting product might gel.

In one embodiment the resulting product has a mixture of about 2-10% by weight scale inhibitor, with the balance being the FRL.

Various types of scale inhibitors can be utilized. In one embodiment the scale inhibitor comprises a homopolymer. In one embodiment the scale inhibitor comprises a polyacrylic, a homopolymer of acrylic acid. This is for illustrative purposes only and should not be deemed limiting. Other chemistries for the scale inhibitors can be utilized. This includes phosphorate based chemistries and co-polymer based chemistries.

As noted, in one embodiment the combination fluid has excellent friction reduction with an added benefit of preventing alkaline earth metal scale deposits. These can include calcium carbonate, calcium sulfate, barium sulfate, and others. As noted, the combination fluid can be used in a wide variety of oilfield waters from fresh to produced.

In one embodiment, comparatively less combination fluid is needed compared to prior separate FRL and a separate scale inhibitor. A reduction in fluid results in significant cost savings as well as a positive environmental impact.

While the invention has been particularly shown and described with reference to a preferred embodiment, it will be understood by those skilled in the art that various changes in form and detail may be made therein without departing from the spirit and scope of the invention.

What is claimed is:

1. A system for a friction reducing liquid, said system comprising:
a friction reducing liquid;
a scale inhibitor.

2. The system of claim 1 wherein said system comprises between 2-10% by weight scale inhibitor.

3. The system of claim 1 wherein said friction reducing liquid comprises an anionic polyacrylamide.

4. The system of claim 1 wherein said scale inhibitor comprises polyacrylic.

5. The system of claim 1 wherein said scale inhibitor comprises a homopolymer.

6. The system of claim 1 wherein said friction reducing liquid comprises an AMPS copolymer liquid friction reducer.
